(19) United States
(12) Patent Application Publication
(10) Pub. No.: US 2026/0075349 A1
(43) Pub. Date: Mar. 12, 2026

(54) EAR DEVICE

(71) Applicant: CASIO COMPUTER CO., LTD., Tokyo (JP)

(72) Inventors: Masaru JINDE, Tokyo (JP); Shinobu SUGIOKA, Tokyo (JP); Chihiro SUZUKI, Tokyo (JP)

(73) Assignee: CASIO COMPUTER CO., LTD., Tokyo (JP)

(21) Appl. No.: 19/325,251

(22) Filed: Sep. 10, 2025

(30) Foreign Application Priority Data
Sep. 11, 2024 (JP) 2024-157176

(51) Int. Cl. H04R 1/10

(52) U.S. Cl. CPC H04R 1/1058; H04R 1/1016; H04R 1/105

(57) ABSTRACT

Disclosed is an ear device including: a sound emitting section that is to be placed on a side of an outer ear including a cavum conchae and includes a sound output port through which sound is output to an outside; a main body that is to be placed on a back side of the outer ear; a connecting section that connects the sound emitting section and the main body to each other; and an exterior member that is detachably attached to the connecting section or the sound emitting section.

### REFERENCE TO RELATED APPLICATIONS

This application is based upon and claims the benefit of priority from the prior Japanese Patent Application No. 2024-157176 filed on Sep. 11, 2024, the entire contents of which are incorporated herein by reference.

### TECHNICAL FIELD

This disclosure relates to an ear device.

### DESCRIPTION OF RELATED ART

Various types of ear devices that are mounted on the ear have been known. For example, JP 2013-115799A describes a bone conduction ear-hook hearing aid as an ear device.

### SUMMARY OF THE INVENTION

An ear device according to the present disclosure comprises: a sound emitting section that is to be placed on a side of an outer ear including a cavum conchae and includes a sound output port through which sound is output to an outside; a main body that is to be placed on a back side of the outer ear; a connecting section that connects the sound emitting section and the main body to each other; and an exterior member that is detachably attached to the connecting section or the sound emitting section.

### BRIEF DESCRIPTION OF DRAWINGS

In the drawings:

FIG. 1 is a schematic perspective view of a main portion of an ear device according to an embodiment mounted on the ear;

FIG. 2 is a side view of a main portion of the ear device according to the embodiment;

FIG. 3 is an explanatory diagram illustrating a positional relationship from a sound hole to an entrance of an external auditory meatus when the ear device according to the embodiment is mounted on the ear;

FIG. 4 is a perspective view of a main portion of the ear device with an adjustment member removed;

FIG. 5A is a schematic side view of an example of the adjustment member illustrating an S-size adjustment member;

FIG. 5B is a schematic side view of an example of the adjustment member illustrating an M-size adjustment member;

FIG. 5C is a schematic side view of an example of the adjustment member illustrating an L-size adjustment member;

FIG. 6 is a perspective view of a main portion of an attachment portion between a connecting section and an exterior member;

FIG. 7 is a perspective view of a main portion of an example of the ear device according to the embodiment;

FIG. 8 is a perspective view of a main portion of an example of the ear device according to the embodiment;

FIG. 9 is a perspective view of a main portion of an attachment portion between a connecting section and an exterior member according to a variation;

FIG. 10 is a perspective view of a main portion of an ear device that includes a locking part illustrated in FIG. 9;

FIG. 11 is a side view of a main portion of an ear device according to a variation;

FIG. 12 is a perspective view of a main portion of the ear device according to the variation;

FIG. 13 is a side view of a main portion of an ear device according to a variation;

FIG. 14 is a perspective view of a main portion of the ear device according to the variation;

FIG. 15 is a perspective view of a main portion of the ear device illustrated in FIGS. 13 and 14;

FIG. 16 is a perspective view of a main portion of an ear device in which an exterior member includes a spacer on a side where the exterior member is attached to a sound emitting section;

FIG. 17 is an exploded perspective view of a main portion of the ear device illustrated in FIG. 15; and

FIG. 18 is an exploded perspective view of a main portion of the ear device illustrated in FIG. 16.

### DETAILED DESCRIPTION

FIG. 4 of JP 2013-115799A illustrates an ear device (ear-hook hearing aid) that goes around from the front side of the ear, which is a side including the entrance of the external auditory meatus, to the back side of the ear, which is a side facing the temporal region, to be worn like an ear cuff.

However, an ear device is expected to be used on a daily basis. Therefore, an ear device can be used in a variety of situations, from casual to formal. If the appearance of an ear device can be changed just like changing an accessory depending on the situation in which the ear device is mounted, a single ear device can be naturally mounted in a variety of situations.

The present disclosure relates to an ear device whose appearance can be changed according to the application, usage situation, or the like.

According to the present disclosure, it is possible to obtain an effect that the appearance of an ear device can be changed according to the application, usage situation, or the like.

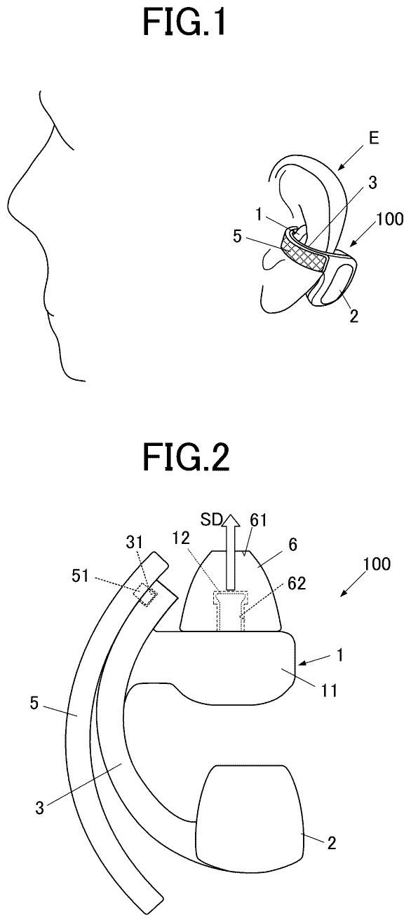

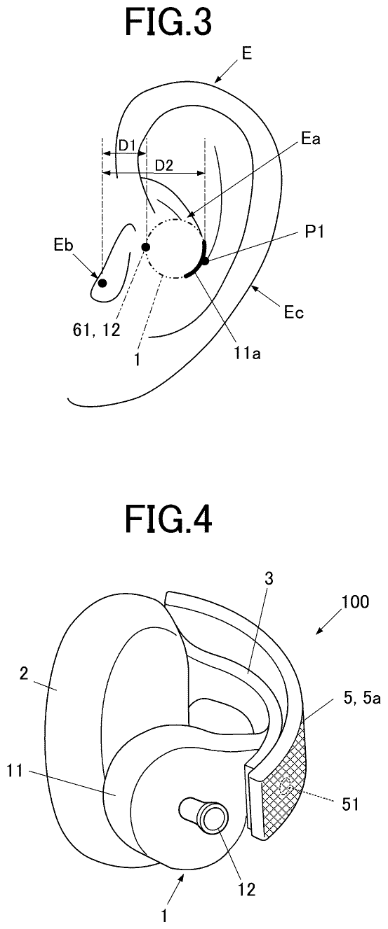

With reference to FIGS. 1 to 10, one embodiment of an ear device 100 according to the present invention will be described. As illustrated in FIG. 1, the ear device 100 according to the embodiment is used when mounted on the ear E. As illustrated in FIG. 1, FIG. 2, and the like, the ear device 100 includes a sound emitting section 1, a main body 2, a connecting section 3 that connects the sound emitting section 1 and the main body 2 to each other, and an exterior member 5 attached to the connecting section 3. The sound emitting section 1 is placed on the front side of the ear E (side including the external auditory meatus entrance Eb illustrated in FIG. 3). The main body 2 is placed on the back side of the ear E. The sound emitting section 1 and the main body 2 are connected by the connecting section 3. As a result, for example, as illustrated in FIG. 1, the connecting section 3, to which the exterior member 5 is attached, crosses the helix (Ec) from the front side to the back side of the ear, giving the ear device 100 an appearance as if an ear cuff were worn. The embodiment described below is provided with various limitations technically preferable for carrying out the present invention. However, the scope of the present invention is not limited to the embodiment below or illustrated examples.

The main body 2 includes, in a housing made of various types of resin or the like, a power supplier such as a battery, a communication module for wireless communication by Bluetooth (registered trademark) or the like, and various circuit boards (all not shown). The main body 2 is placed on the back side of the ear E, between the ear E and the head. The main body 2 and the sound emitting section 1 have a positional relationship in which the sound emitting section 1 and the main body 2 are placed substantially on the front side and the back side of the ear, respectively, sandwiching a portion of the cavum conchae Ea, where the portion is closer to the external auditory meatus entrance Eb than to the helix Ec (see FIG. 3).

The sound emitting section 1 includes a housing 11 made of various types of resin or the like. In examples illustrated in FIG. 2 and the like, the housing 11 is formed so that its outer shape is substantially disk-shaped or hemispherical. The shape of the housing 11 is not limited to the examples illustrated in the drawings. A driver unit (not shown) is housed inside the housing 11. The driver unit converts an electrical signal into a sound and includes, for example, a diaphragm, coil, and magnet (all not shown). When the ear device 100 is an earphone, an electrical signal (audio signal) supplied from an external device is converted into a sound (vibration) by the driver unit. When the ear device 100 is a hearing aid, the ear device 100 further includes a microphone, amplifier, and the like (all not shown). The microphone is a sound wave input section (sound collecting section) that collects a sound wave (sound data) from the outside. The sound wave (sound data) collected by the microphone is input to an amplifier to be converted into an electrical signal and amplified as appropriate. Furthermore, this electrical signal is supplied to the driver unit to be converted into a sound.

The sound emitting section 1 includes a sound output port 12 that outputs the sound converted by the driver unit to the outside. In examples illustrated in FIGS. 2, 4, and the like, a surface of the housing 11 on a side facing the external auditory meatus is flat, and the sound output port 12 protrudes from substantially the center of this flat surface toward the external auditory meatus (i.e., the external auditory meatus entrance Eb illustrated in FIG. 3). The sound is output in the protruding direction of the sound output port 12. The sound output direction SD is indicated by a white arrow in FIG. 2 and the like. As illustrated in FIG. 3, the sound emitting section 1 has a portion of the housing 11 in contact with the front surface of the ear E when the ear device 100 is mounted. More specifically, the sound emitting section 1 is locked in the cavum conchae Ea. In FIG. 3, a position on the front surface of the ear E with which the portion of the housing 11 of the sound emitting section 1 is in contact is defined as a mounting point P1. An outer peripheral portion of the sound emitting section 1 (housing 11) that contacts the mounting point P1 is defined as a contact portion 11a. In FIG. 3, the sound emitting section 1 mounted on the ear E is schematically shown in a substantially circular shape by a one-dot chain line. The sound output port 12 is disposed on a side facing the entrance of the external auditory meatus (ear hole), which is defined as the external auditory meatus entrance Eb in FIG. 3, when the sound emitting section 1 is locked in the cavum conchae Ea. An adjustment member 6 can be attached to the sound emitting section 1 on the side facing the external auditory meatus. The adjustment member 6 is an ear-tip (also called an earpiece) formed of silicone, urethane resin, or the like, and is preferably elastically deformable. The material used to form the adjustment member 6 is not limited to those exemplified here.

As illustrated in FIG. 2 and the like, the adjustment member 6 is substantially trapezoidal in side view and has a locking hole 62 into which the sound output port 12 can be inserted. FIG. 4 illustrates the ear device 100 illustrated in FIG. 2 with the adjustment member 6 removed. As illustrated in FIG. 4 and the like, the distal end portion of the sound output port 12 protrudes outward, and the locking hole 62 of the adjustment member 6 is shaped to be locked to the protruding portion of the sound output port 12. This makes it difficult for the adjustment member 6 to come out once the sound output port 12 is inserted into the locking hole 62. A sound hole 61 communicating with the sound output port 12 is provided in the adjustment member 6 on a side facing the external auditory meatus. The shape and configuration of the adjustment member 6 is not particularly limited. For example, the adjustment member 6 may be solid or hollow except for a portion leading from the locking hole 62 to the sound hole 61. The configuration in which the sound output port 12 is locked to the locking hole 62 is also not limited. When the adjustment member 6 is attached to the sound output port 12 of the sound emitting section 1, the sound converted by the driver unit is output to the outside through the sound hole 61 of the adjustment member 6 that communicates with the sound output port 12. The sound hole 61 that emits the sound from the sound output port 12 is positioned outside the external auditory meatus and adjacent to the external auditory meatus entrance Eb (see FIG. 3).

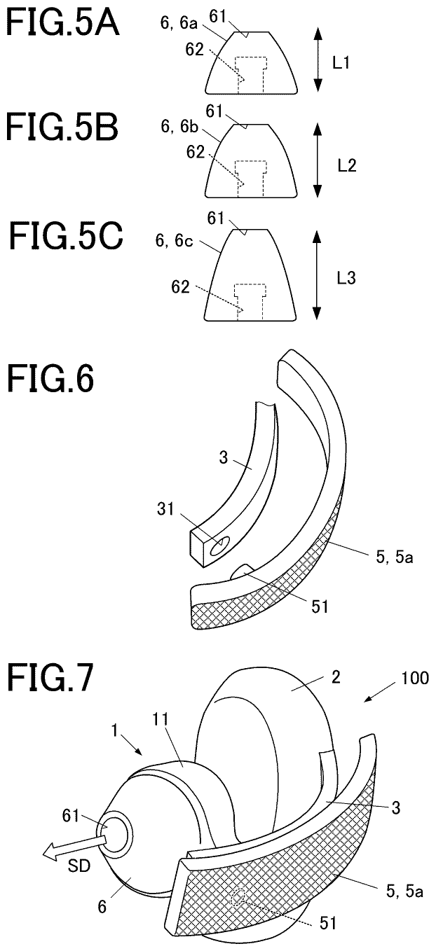

In the embodiment, the adjustment member 6 is prepared with a plurality of adjustment members 6 having different lengths L in the sound output direction SD and can be exchangeably attached as appropriate. Specifically, for example, an S-size adjustment member 6a with a short length L in the sound output direction SD (length L1 in FIG. 5A) as illustrated in FIG. 5A, an L-size adjustment member 6c with a long length L in the sound output direction SD (length L3 in FIG. 5C) as illustrated in FIG. 5C, and an M-size adjustment member 6b with an intermediate length between the lengths of the adjustment members 6a and 6c (length L2 in FIG. 5B) as illustrated in FIG. 5B are prepared. The types and number of adjustment members 6 prepared are not limited to those illustrated here. There may be two types of an M-size adjustment member 6b and an L-size adjustment member 6c, or more than four types of adjustment members 6 with different sizes and shapes.

When sound is listened to in an open manner without the ear device 100 inserted into the external auditory meatus entrance Eb, in order to hear clear sound through the ear device 100, it is preferable that a distance from a portion through which the sound is output to the external auditory meatus entrance Eb is about 5 mm or less. However, the size and shape of the ear E varies from person to person. For example, for a user with a wide cavum conchae Ea, the distance D2 from the mounting point P1 to the external auditory meatus entrance Eb becomes longer, and the distance from the sound output port 12 to the external auditory meatus entrance Eb may greatly exceed 5 mm. Here, the mounting point P1 is where the sound emitting section 1 contacts the ear E when the sound emitting section 1 is locked in the cavum conchae Ea. The adjustment members 6 accommodate such variations in the size and the like of the ear E from person to person and adjust the sound hole 61, which is the portion through which the sound is output, to a position within 5 mm of the external auditory meatus entrance Eb. For example, for a user with a large ear E and a long distance D2, an L-size adjustment member 6 is attached to the sound emitting section 1. For a user with a short distance D2, an S-size adjustment member 6 is attached to the sound emitting section 1. This allows the position through which sound is output (position of the sound hole 61) to be within 5 mm of the external auditory meatus entrance Eb, regardless of the size of the ear E. When the ear E is small and the distance from the sound output port 12 to the ear external auditory meatus Eb is 5 mm or less, the ear device 100 may be used without the adjustment member 6, as illustrated in FIG. 4, for example. In this case, the sound output port 12 functions as a sound hole through which sound is output as it is.

The connecting section 3 is an arm-shaped portion that connects the sound emitting section 1 and the main body 2 to each other. The sound emitting section 1 can receive an electrical signal and power supply from the main body 2 via the connecting section 3. The connecting section 3 is formed of an elastically deformable resin. A support column (not shown) is provided inside the connecting section 3. The support column is made of metal, such as titanium, for example. The elastically deformable connecting section 3 can be stabilized along the helix Ec by the metal support column supporting the connecting section 3. This allows the sound emitting section 1 and the main body 2, which are connected by the connecting section 3, to pinch the helix Ec with an appropriate pressing force to hold the ear device 100 in place in the ear E. The connecting section 3 may go around the outer side of at least one of the antihelix, helix Ec, and earlobe of the outer ear.

The exterior member 5 is a decorative member that is detachably attached to the connecting section 3 or the sound emitting section 1. As illustrated in FIG. 1, when the ear device 100 is mounted, the exterior member 5 is disposed so as to cover the outside of the connecting section 3. The material used to form the exterior member 5 is not particularly limited. However, it is preferable that a relatively lightweight metal sheet, such as aluminum or titanium is used to form the exterior member 5. In this case, the exterior member 5 is more rigid and less deformable than the connecting section 3. By forming the exterior member 5 from metal, it is possible to achieve a luxurious appearance as if it were an accessory (e.g., an ear cuff). The exterior member 6 is not limited to those formed of metal. For example, the exterior member 6 may be formed of various resins. In this case, a metallic surface finish is preferred. The exterior member may be formed of various materials such as glass and ceramics. In the embodiment, the exterior member 5 is locked to the connecting section 3 with a magnet, allowing the exterior member 5 to be easily attached and detached.

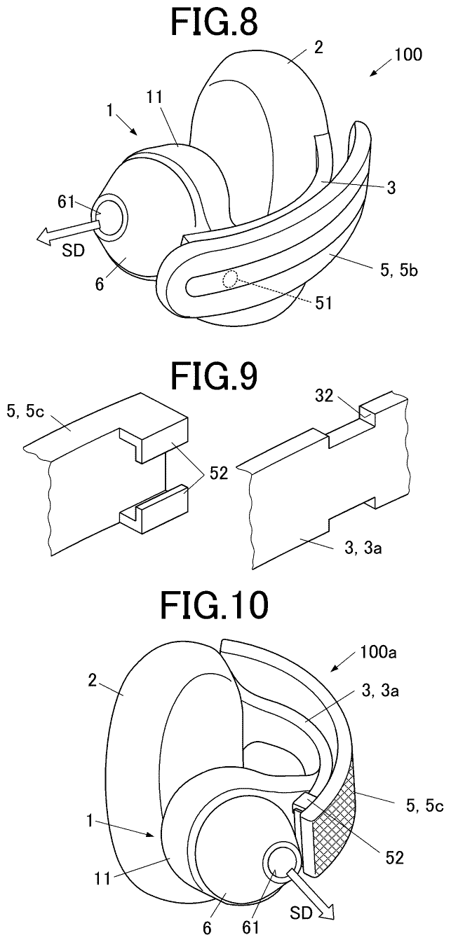

Specifically, as illustrated in FIG. 6, an exterior-side magnet 51 is provided in the exterior member 5 on the connecting side with the connecting section 3, and a locking part 31 is provided in the connecting section 3 at a position corresponding to the exterior-side magnet 51. For example, the locking part 31 includes a magnet or a metal capable of attracting a magnet that is disposed in a recess for receiving the exterior-side magnet 51. When a magnet is disposed in the recess, a magnet having magnetism that attracts the exterior-side magnet 51 is applied. This allows the exterior-side magnet 51 to be easily received into the recess simply by bringing the exterior-side magnet 51 close to the locking part 31, thereby connecting the exterior member 5 to the connecting section 3. In the embodiment, a plurality of different exterior members 5 are prepared so as to be exchangeable from each other. For example, FIGS. 1, 7 and the like illustrate an example of the exterior member 5 (exterior member 5a) with a relatively colorful first color or a first pattern, which is expected to be mounted in casual situations. In contrast, FIG. 8 illustrates an example of the exterior member 5 (exterior member 5b) with a subdued second color or a second pattern, which is expected to be mounted in situations where formal attire is required, such as business, weddings, and funerals. Here, examples of the second color include colors that are less bright and/or less chromatic than the first color. Examples of the second pattern include a pattern having more rounded portions and fewer acute-angled portions than the first pattern, a continuous pattern, and a plain pattern. FIGS. 7, 8, and the like illustrate only examples of the exterior member 5. The exterior member 5 may be prepared with a plurality of different exterior members 5 having different colors, patterns, and/or shapes that is exchangeable from each other.

Connecting the exterior member 5 to the connecting section 3 with a magnet allows the exterior member to be easily attached and detached. This makes it easy for the exterior member 5 to be easily exchanged with a different exterior member 5. Also, attaching the exterior member 5 to the connection 3 in a way that allows for easy attachment and detachment is expected to enable the exterior member 5 to be easily detached from the connecting section 3 when the ear device 100 is accidentally dropped. This prevents an excessive force from being applied to a connecting portion between the exterior member 5 and the connecting section 3, as well as to the entire ear device 100, thereby preventing damage. The method for attaching the exterior member 5 to the connecting section 3 is not limited to the method using a magnet. For example, as illustrated in FIG. 9, a locking claw 52 may be provided in the exterior member 5 (exterior member 5c), and a locking receiving portion 32 to which the locking claw 52 (locking portion) is locked may be formed in the connecting section 3 (connecting section 3a). In this case, as illustrated in FIG. 10, the exterior member 5 (exterior member 5c) is connected to the connecting section 3 (connecting section 3a) by fitting the locking claw 52 into the locking receiving portion 32. Other methods for connecting the exterior member 5 to the connecting section 3 are widely applicable as long as the exterior member 5 can be detachably attached.

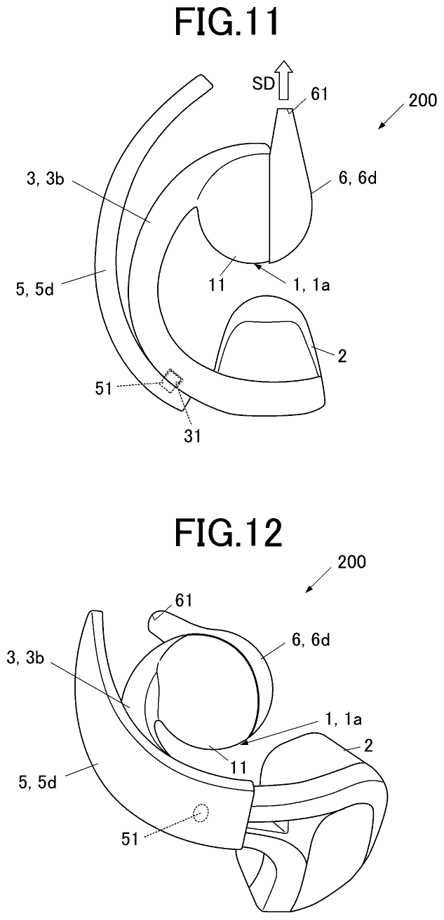

The exterior member 5 is locked to one of two end portions of the connecting section 3, and not the other. One end portion of the connecting section 3 is adjacent to the sound emitting section 1, and the other end portion is adjacent to the main body 2. Locking the exterior member 5 only to one end portion of the connecting section 3 and leaving the other end portion free allows the connecting section 3 to be flexibly bent and deformed even after the exterior member 5 made of metal or the like is attached. Therefore, when the sound emitting section 1 and the main body 2 pinch the helix Ec from the front and back sides, the connecting section 3 can be naturally aligned with the ear E, allowing the ear device 100 to be locked to the ear E. FIGS. 2, 7, 8, and the like illustrate cases where the exterior-side magnet 51 of the exterior member 5 is provided in the end portion of the connecting section 3 adjacent to the sound emitting section 1, and the exterior member 5 is locked to the connecting section 3 at a position adjacent to the sound emitting section 1. When the exterior member 5 is to be locked to the connecting section 3 at a position adjacent to the main body 2, a configuration such as that illustrated in FIGS. 11 and 12 is employed, for example.

That is, in an ear device 200 illustrated in FIGS. 11 and 12, a locking part 31 is provided in one end portion of the connecting section 3 (connecting section 3b) adjacent to the main body 2, and an exterior-side magnet 51 is provided in the exterior member 5 at a position corresponding to the locking part 31 of the connecting section 3b on a side where the exterior member 5 (exterior member 5d) is attached to the connecting section 3b. In this case, the exterior member 5d is locked to the connecting section 3b at a position adjacent to the main body 2, and the other end portion of the connecting section 3b adjacent to the sound emitting section 1 (sound emitting section 1a) is free. In this case as well, the sound emitting section 1 (sound emitting section 1a) may have a disk-shape similar to that illustrated in FIG. 2 and the like. However, in FIGS. 11 and 12, a case where the sound emitting section 1 (sound emitting section 1a) has a substantially spherical shape is illustrated. In this case, as illustrated in FIGS. 11 and 12, an adjustment member 6d having a shape that covers the spherical sound emitting section 1a may be attached as the adjustment member 6. For example, a method for attaching the adjustment member 6d includes: providing a groove or the like (not shown) in the sound emitting section 1a; providing, in the adjustment member 6d, a protruding portion or the like that fits into the groove; and fitting the protruding portion into the groove. The method for attaching the adjustment member 6d is not limited to this. The adjustment member 6d has a sound hole 61 protruding in the sound output direction SD illustrated in FIG. 11, and the sound converted by the driver unit of the sound emitting section 1a is emitted from the sound hole 61 of the adjustment member 6d to the outside.

Next, the operation of the ear device 100 according to the present embodiment will be described with reference to the drawings. First, a user attaches one of the exterior members 5 to the connecting section 3 according to the application or usage situation of the ear device 100. For example, when the ear device 100 is to be mounted in a casual situation such as shopping, the exterior member 5a illustrated in FIG. 1, FIG. 4, or the like having a colorful color or pattern is attached to the connecting section 3. According to the size of the user's ear E and the like, the user selects an adjustment member 6 as necessary so that the distance from the sound hole 61 to the external auditory meatus entrance Eb is about 5 mm and attaches the adjustment member 6 to the sound emitting section 1. When the user mounts the ear device 100 according to the embodiment on the ear E, the sound emitting section 1 is placed in the cavum conchae Ea in such an orientation that the sound output port 12 (sound hole 61 of the adjustment member 6 communicating with the sound output port 12) faces the external auditory meatus entrance Eb of the ear E, as illustrated in FIG. 1. The main body 2 connected to the sound emitting section 1 by the connecting section 3 is placed on the back side of the helix Ec. The ear device 100 is held in place in the ear E by pinching the helix Ec with the sound emitting section 1 and the main body 2. This allows the exterior member 5a to cross the helix Ec, enabling the ear device 100 to be mounted with an appearance as if an ear cuff were worn.

When the sound hole 61 is felt to be far from the external auditory meatus entrance Eb, the distance from the sound hole 61 to the external auditory meatus entrance Eb is suitably adjusted, for example, by exchanging the adjustment member 6 with that illustrated in FIG. 5C. When it is desired that the same ear device 100 is mounted in a formal situation such as business, the exterior member 5a is detached from the connecting section 3 by removing the exterior-side magnet 51 from the locking part 31. Then, for example, the exterior member 5b having a simple color or pattern illustrated in FIG. 8 is attached to the connecting section 3. In this case as well, simply bringing the exterior member 5b close to the connecting section 3 causes the exterior-side magnet 51 provided in the exterior member 5b to be attracted to the locking part 31 of the connecting section 3, thereby easily locking the exterior member 5b. This allows the exterior member 5b to be attached to the connecting section 3, enabling the ear device 100 to be used comfortably in business situations. Thus, the ear device 100 according to the embodiment allows the user to easily exchange the exterior member 5 that is disposed outside the connecting section 3, which is a position that greatly affects the appearance of the ear device 100, enabling a single device to be used in various situations.

As described above, the ear device 100 according to the present embodiment includes: the sound emitting section 1 that includes the sound output port 12 through which sound is output to the outside; the main body 2 that is to be placed between the back side of the ear E and the head; the connecting section 3 that connects the sound emitting section 1 and the main body 2 to each other; and the exterior member 5 that is detachably attached to the connecting section 3 or the sound emitting section 1. The sound hole 61 through which the sound from the sound output port 12 is output is to be positioned outside the external auditory meatus and adjacent to the external auditory meatus entrance Eb. The exterior member 5 may be prepared with a plurality of different exterior members 5 that is exchangeable from each other. For example, when the ear device 100 is a hearing aid or sound collector, the ear device is an essential part of daily life for the user. Even when the ear device 100 is simply an earphone for listening to sound, the ear device can be mounted in a variety of situations, from casual to formal, including business situations such as online meetings. Preparing an ear device corresponding to each situation is troublesome, and if an ear device is not suitable for the usage situation, people tend to refrain from using the ear device. In this regard, the ear device 100 according to the embodiment can easily change the appearance of the ear device 100 according to the application, usage situation, or the like. For example, when the ear device 100 is a hearing aid, the ear device can be made to look like an accessory. This allows the user to casually mount the ear device 100 when s/he goes out. The ear device 100 according to the embodiment also enables the user to enjoy changing the appearance of a single device as if it were a plurality of different devices.

The exterior member 5 according to the embodiment may be locked to the connecting section 3 with a magnet (exterior-side magnet 51). When a magnet is used to attach the exterior member 5 to the connecting section 3, the exterior member 5 can be easily attached and detached. In addition, the user can easily attach the exterior member 5, without having to do any detailed work with the fingertips, simply by bringing the exterior member 5 close to the connecting section 3 due to the magnetic attraction force. Furthermore, even when the ear device 100 is accidentally dropped, the attachment portion is less likely to be damaged as compared with the case where the ear device is locked by using a claw or the like.

Also, the exterior member 5 according to the embodiment is locked to one of the two end portions of the connecting section 3, and not the other. One end portion of the connecting section 3 is adjacent to the sound emitting section 1, and the other end portion is adjacent to the main body 2. By locking the exterior member 5 only to one end portion of the connecting section 3 and leaving the other end portion free, even when the exterior member 5 made of a material having almost no deformability such as metal is attached, the connecting section 3 can be freely deformed to fit comfortably along the ear E.

In the embodiment, one of multiple adjustment members 6 having different lengths L in the sound output direction SD can be exchangeably attached to the sound emitting section 1 on the side facing the external auditory meatus (external auditory meatus entrance Eb). The sound hole 61 communicating with the sound output port 12 is provided in the adjustment member 6 on the side facing the external auditory meatus (external auditory meatus entrance Eb). This allows the distance D1 from the sound hole 61 to the external auditory meatus entrance Eb to be adjusted to the most audible distance simply by exchanging the adjustment member 6 attached to the sound emitting section 1, thereby enabling easy adaptation to differences in the size of the user's ear E.

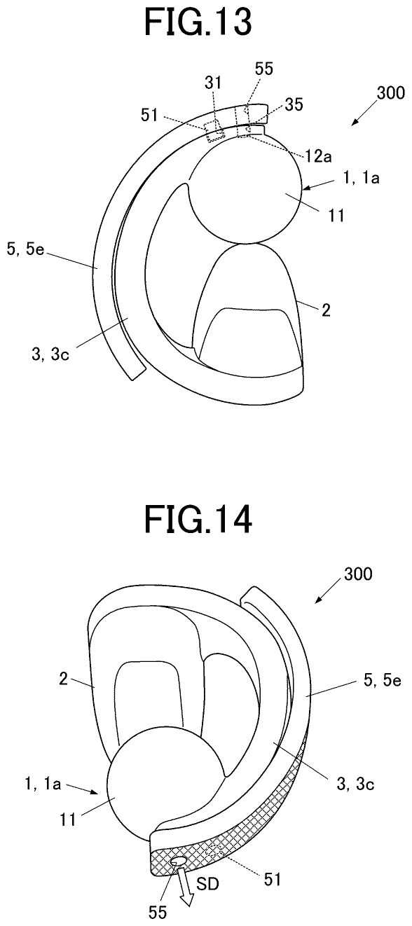

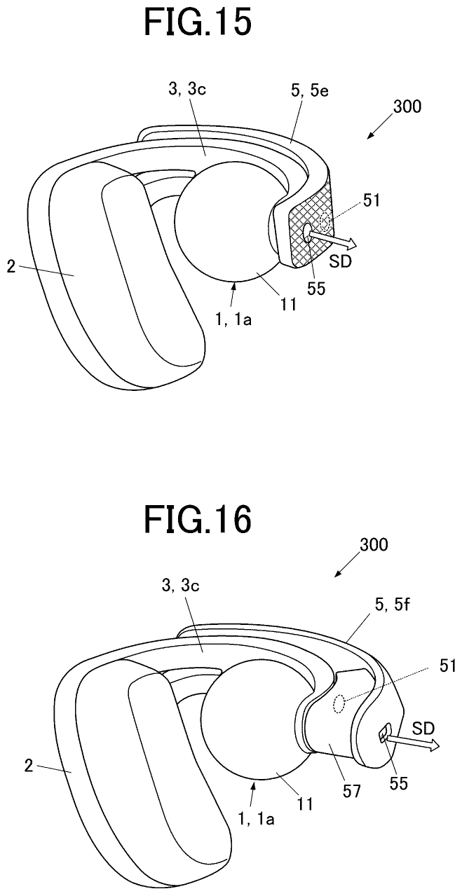

Although an embodiment of the present invention is described above, it is needless to say that the present invention is not limited to the embodiment and various changes can be made without departing from the scope of the present disclosure. For example, in the ear device 100 according to the above-described embodiment, a case where the sound hole 61 is formed in the adjustment member 6 attached to the sound output port 12 of the sound emitting section 1 is exemplified, but the position where the sound hole 61 is provided is not limited thereto. For example, as in an ear device 300 illustrated in FIGS. 13 to 18, a sound hole 55 may be provided in the exterior member 5 (see an exterior member 5e in FIGS. 13, 14, and the like). In this case, the positions of the sound output port 12a and the sound hole 55 are adjusted so that, when the exterior member 5 is attached to the sound emitting section 1 (sound emitting section 1a), the sound output port 12a of the sound emitting section 1a communicates with the sound hole 55. In examples illustrated in FIG. 14 and the like, a portion of the connecting section 3 (connecting section 3c) overlaps a position corresponding to the sound output port 12a, and a communication hole 35 communicating with the sound output port 12a is provided in the overlapping portion of the connecting portion 3c. Then, communication is established from the sound output port 12a to the sound hole 55 through the communication hole 35 communicating with the sound hole 55 provided in the exterior member 5e. It is not essential that the connecting section 3 be interposed between the sound emitting section 1 and the exterior member 5. The sound output port 12a of the sound emitting section 1a may directly communicate with the sound hole 55 of the exterior member 5e. Thus, by providing the sound holes 55 in the exterior member 5, sound can be emitted from the exterior member 5 toward the external auditory meatus (external auditory meatus entrance Eb), enabling the realization of an ear device 300 with a design in which the exterior member 5 is inserted up to the vicinity of the external auditory canal entrance Eb.

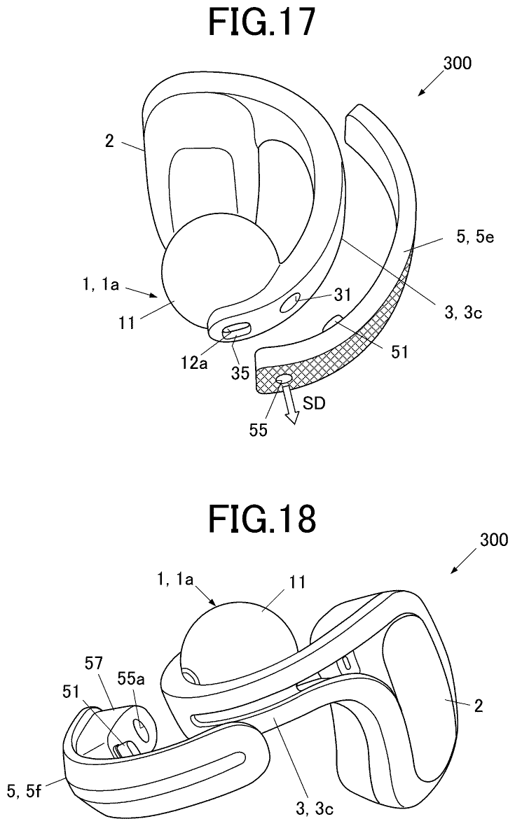

When the sound hole 55 is provided in the exterior member 5, the exterior member 5 (exterior member 5e) may include a spacer 57 in a portion where the exterior member 5 is attached to the sound emitting section 1 (sound emitting section 1a), as illustrated in FIGS. 16 and 18. In this case, the spacer 57 communicates with the sound output port 12a of the sound emitting section 1 (sound emitting section 1a) and the sound hole 55 of the exterior member 5 (exterior member 5e). That is, a communication hole 55a is formed in the spacer 57 so as to allow communication from the sound output port 12a to the sound hole 55. Furthermore, as described above, when a portion of the connecting section 3 (connecting section 3c) overlaps the sound emitting section 1 (sound emitting section 1a) and this overlapping portion has a communication hole 35 that communicates with the sound output port 12a, communication is established from the sound output port 12a to the sound hole 55 through the communication hole 35 and the communication hole 55a. Thus, by providing, on the side where the exterior member is attached to the sound emitting section 1, the spacer 57 that allows for the communication from the sound output port 12a to the sound hole 55, it is possible to adjust the distance D1 from the sound hole 55, through which sound is emitted, to the external auditory meatus entrance Eb to a predetermined distance (e.g., within 5 mm), as in the case of providing the adjustment member 6 in the form of an ear-tip on the sound emitting section 1. The exterior member 5 may be prepared with a plurality of exterior members 5 having the spacers 57 with different thicknesses. In this case, it is possible to make adjustments that appropriately accommodate individual differences such as the size of the ear E for each user.

The exterior member 5 and the spacer 57 are not limited to being one piece. For example, an exterior member 5 in which a sound hole 55 is formed and a spacer detachable from the exterior member 5 may be separate members. In this case, exterior members 5 having different appearances and textures, such as for casual use and formal use, are prepared, and a plurality of spacers having different lengths (heights) between the sound emitting section 1 and the exterior members 5 are prepared. As a result, for example, while using two types of exterior members 5, it is possible to accommodate detailed requirements according to the size of the user's ear E or the like simply by exchanging the spacer. In other words, while suppressing component costs, it is possible to adjust the distance D1 from the sound hole 55 to the external auditory meatus entrance Eb to a predetermined distance (e.g., within 5 mm).

Although some embodiments of the present invention have been described above, the scope of the present invention is not limited to the embodiments described above but includes the scope of the invention described in the claims and its equivalents.

1. An ear device comprising:
a sound emitting section that is to be placed on a side of an outer ear including a cavum conchae and includes a sound output port through which sound is output to an outside;
a main body that is to be placed on a back side of the outer ear;
a connecting section that connects the sound emitting section and the main body to each other; and
an exterior member that is detachably attached to the connecting section or the sound emitting section.

2. The ear device according to claim 1, wherein the exterior member includes a plurality of different exterior members that is exchangeable from each other.

3. The ear device according to claim 1, wherein the exterior member is locked to the connecting section or the sound emitting section with a magnet.

4. The ear device according to claim 1, wherein
the exterior member includes a locking part,
the connecting section or the sound emitting section includes a locking receiving part, and
the locking part is locked to the locking receiving part.

5. The ear device according to claim 1, wherein the exterior member is locked to one portion of the connecting section and is not locked to another portion of the connecting section, the one portion being adjacent to the sound emitting section, the other portion being adjacent to the main body.

6. The ear device according to claim 1, wherein the exterior member is locked to one portion of the connecting section and is not locked to another portion of the connecting section, the one portion being adjacent to the main body, the other portion being adjacent to the sound emitting section.

7. The ear device according to claim 1, wherein a sound hole of the ear device is to be positioned outside an external auditory meatus of the outer ear and adjacent to an entrance of the external auditory meatus, the sound hole being a hole through which the sound from the sound output port is emitted.

8. The ear device according to claim 1, wherein
one of multiple adjustment members having different lengths in a sound output direction is exchangeably attached to the sound emitting section on a side facing an external auditory meatus of the outer ear,
each of the multiple adjustment members has a sound hole on a side facing the external auditory meatus, and
the sound hole communicates with the sound output port.

9. The ear device according to claim 1, wherein
the exterior member has a sound hole, and
the sound hole communicates with the sound output port when the exterior member is attached to the sound emitting section.

10. The ear device according to claim 9, wherein
the exterior member includes a spacer in a portion where the exterior member is attached to the sound emitting section, and
the spacer communicates with the sound output port and the sound hole when the exterior member is attached to the sound emitting section.
